(19) United States
(12) Patent Application Publication
(10) Pub. No.: US 2026/0350523 A1
(43) Pub. Date: Nov. 5, 2026

(54) SYSTEMS AND METHODS FOR RAPID CONTROL TARGET STATE CONVERGENCE USING LOGICALLY-TIERED TOPOLOGY INSTRUCTIONS AND STRUCTURED EXECUTION VERIFICATION

(71) Applicant: Bryan Michael Perdue, Brentwood, TN (US)

(72) Inventor: Bryan Michael Perdue, Brentwood, TN (US)

(21) Appl. No.: 19/663,568

(22) Filed: Apr. 30, 2026

Related U.S. Application Data
(60) Provisional application No. 63/797,797, filed on Apr. 30, 2025.

(51) Int. Cl. G06Q 10/0639

(52) U.S. Cl. CPC G06Q 10/06393

(57) ABSTRACT

A computer-implemented system and method enable users to interact with business performance measured variables retrieved from external data sources and receive AI-generated control actions to improve those measured variables. The system displays performance data as interactive measured variables within a user interface, receives a user inputidentifying a measured variable as a focus control target state with a target value, and automatically generates recommended control actions tailored to achieve the target via an AI strategy engine that analyzes the performance data. Progress towards the target is tracked through time-triggered execution verification events. In preferred embodiments, the system incorporates reinforcement-based streak counters, assigned execution entity designation, control actions extracted from business literature, a closed-loop feedback mechanism that refines control actions based on tracked observed results, computationalal performance computational outputs, and hierarchical multi-entity data presentation.

### REFERENCE TO RELATED APPLICATIONS

This application claims the benefit of US Provisional Patent Application No. 63/797,797, filed on Apr. 30, 2025, and incorporated herein by reference.

### BACKGROUND OF THE INVENTION

### Technical Field

This invention relates to computer-implemented systems and methods for goal setting, performance management, and accountability, and more particularly to systems integrating artificial intelligence, real-time data analysis, curated strategy selection, and gamified accountability mechanimobile short-form communication to accelerate goal achievement in business and personal contexts.

### Description of the Related Art

Traditional goal-tracking and performance management tools often lack seamless integration with real-time data, provide generic reminders without tailored strategic guidance, involve complex setup processes hindering user adoption, and lack robust accountability structures. Users frequently struggle with fragmented systems, needing to manually consult separate analytics dashboards, strategy documents, and communication platforms. From a technical standpoint, existing systems suffer from three specific computational limitations: first, they require users to maintain separate data connections to disparate external sources without automated correlation between retrieved performance data and available strategic responses; second, they lack an logically-tiered topological computational pipeline capable of analyzing multiple performance measured variables simultaneously against a corpus of potential control actions to generate tailored recommendations in real time; and third, they provide no automated feedback mechanism whereby tracked progress outcomes are used to refine and improve subsequent strategy recommendations, resulting in static rather than adaptive guidance. This lack of integration, personalized guidance, and sustained engagement hinders effective progress and reduces the likelihood of goal completion. For example, existing systems may require manual data input, which is time-consuming and error-prone, or they may provide only basic reminders without actionable insights. Additionally, many tools do not facilitate structured accountability, leaving users without the necessary support to stay on track. There is a clear need for a unified system that overcomes these computational shortcomings by seamlessly integrating automated data retrieval, logically-tiered topological strategy analysis, and structured accountability tracking into a single closed-loop pipeline to support effective and rapid goal achievement.

### SUMMARY OF THE INVENTION

Embodiments of the invention may include one or more of the following features. These features may be used singly, or in combination with each other.

The present invention provides a computer-implemented system and method that retrieves real-time performance measured variables from external business data sources, presents those measured variables to the user in interactive context presentation modes, and when the user identifies a measured variable requiring improvement, automatically generates logically-tiered topology control actions specifically tailored to achieve a user-defined target value for that measured variable. The system's core innovation is the measured variable-to-strategy pipeline: a Data Interface Module (20) retrieves live performance data from sources such as CRM systems, accounting platforms, and business tools; a User Interface Module (50) displays these measured variables in interactive presentation modes where the user can click on any measured variable to select it as a focus goal; an AI Strategy Engine (40) analyzes the performance data corresponding to the selected measured variable and the user's target value to generate recommended control actions for improving that measured variable; and a Tracking and Notification Module (100) monitors progress towards the target through time-triggered accountability events. In preferred embodiments, the system further incorporates gamified accountability with streak counters managed by an Accountability Module (80), responsible agent designation with restricted access via an Access Control Module (90), control actions extracted from business literature via Book Summary Processing (130) and Book Integration Components (140), and a closed-loop feedback mechanism whereby tracked progress outcomes are provided back to the AI Strategy Engine (40) to continuously refine and improve future strategy recommendations. By combining these elements into a single closed-loop platform, the invention transforms goal setting from a manual, fragmented process into a dynamic, data-driven experience where every business measured variable becomes an actionable improvement opportunity.

Other features and advantages of the present invention will become apparent from the following more detailed description, taken in conjunction with the accompanying drawings, which illustrate, by way of example, the principles of the invention.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

Aspects described below include a non-transitory computer-readable storage medium comprising computer-executable instructions that, responsive to execution by a processor, cause a system to perform any one of the described methods.

Aspects described below also include a system and method for rapid control target state convergence using logically-tiered topology instructions and structured execution verification.

### BRIEF DESCRIPTION OF THE FIGURES

The appended figures depict certain features of the various aspects described herein and are not to be considered limiting of the scope of this disclosure.

FIG. 1 depicts a block diagram of a data processing environment in which illustrative embodiments may be implemented.

FIG. 2 depicts a block diagram of a data processing system in which illustrative embodiments may be implemented.

FIG. 3A is a flowchart illustrating the first half of the core method for rapid goal achievement, showing the data retrieval, measured variable display, and user goal selection steps (steps a through c), including the Data Interface Module (20), Analysis/Goal Processing Module (30), and User Interface Module (50) receiving data from External Data Sources (120).

FIG. 3B is a flowchart illustrating the second half of the core method, showing the AI strategy generation, responsible agent designation, and gamified accountability tracking steps (steps d through f), including the AI Strategy Engine (40), Strategy Database (70), Accountability Module (80), and Tracking and Notification Module (100).

FIG. 4 is a mockup of the User Interface Module (50) displaying a performance dashboard with interactive clickable measured variables, such as income and expenses, within a scorecard view, where each measured variable displays an associated count of available control actions, and upon selecting a measured variable the system presents a pop-up window containing AI-generated recommended control actions (e.g., “Optimize Sales Funnel”) tailored to improve that specific measured variable, along with a field for assigning a responsible agent for strategy implementation.

FIG. 5 is a user interface screenshot showing a conversational AI interaction screen with a prompt for user input and a series of response options.

FIG. 6 is a user interface screenshot depicting a gamified accountability dashboard with streak counters, check-in statuses, and visual progress indicators.

FIG. 7 is a diagram illustrating multiple context presentation modes for data presentation, including EnumAIStrategyType, Scorecard, AllColumnMeasured variable, AllRowMeasured variables, and Measured variable Score presentation modes.

FIG. 8 is a user interface screenshot showing a gamified weekly challenge screen with a timeline for completing tasks to maintain a streak and options to start a challenge or create a focus goal.

FIG. 9 is a user interface screenshot displaying a goal management dashboard with categorized goals, such as financial, and associated measured variables for tracking progress.

FIG. 10 is a diagram illustrating the system architecture, highlighting the interaction between the Data Interface Module, Analysis/Goal Processing Module, AI Strategy Engine, User Interface Module, Accountability Module, Tracking Module, Access Control Module, External Data Sources, and Strategy Database.

FIG. 11 is a user interface screenshot showing another instance of the conversational AI interaction screen with a prompt for user input, similar to FIG. 5.

FIG. 12 is a conceptual diagram illustrating the integration of book summary control actions into the goal achievement workflow via scorecards and prompts, showing Book Summary Processing, Goal Achievement System, and Book Integration Components.

FIG. 13 is a diagram illustrating hierarchical entity data retrieval, showing the Data Interface Module (20) aggregating performance data from a plurality of child entities organized under a parent entity, and the User Interface Module (50) presenting aggregated parent-level measured variables with drill-down capability to individual child entity performance.

FIG. 14 is a diagram illustrating the generation of a narrative performance report by the Tracking and Notification Module (100) in cooperation with the AI Strategy Engine (40), showing the flow from performance data and focus goal through evaluation and personalized strategic guidance to presentation via the User Interface Module (50).

FIG. 15 is a flowchart illustrating the responsible agent designation process managed by the Accountability Module (80), showing the decision path between user-designated third-agent designation and automatic self-designation when no responsible agent is specified, including the self-directed accountability process with time-triggered self-check-in events and self-assessment prompts.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known structures, functions, methods, procedures, components, and/or circuitry have been described at a relatively high level, without detail, to avoid unnecessarily obscuring aspects of the present teachings.

Unless the state clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

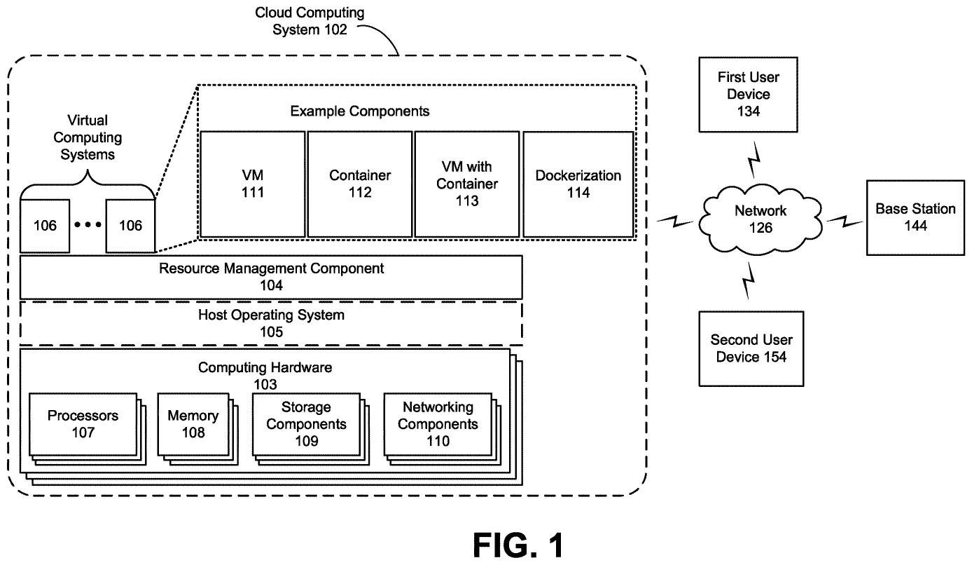

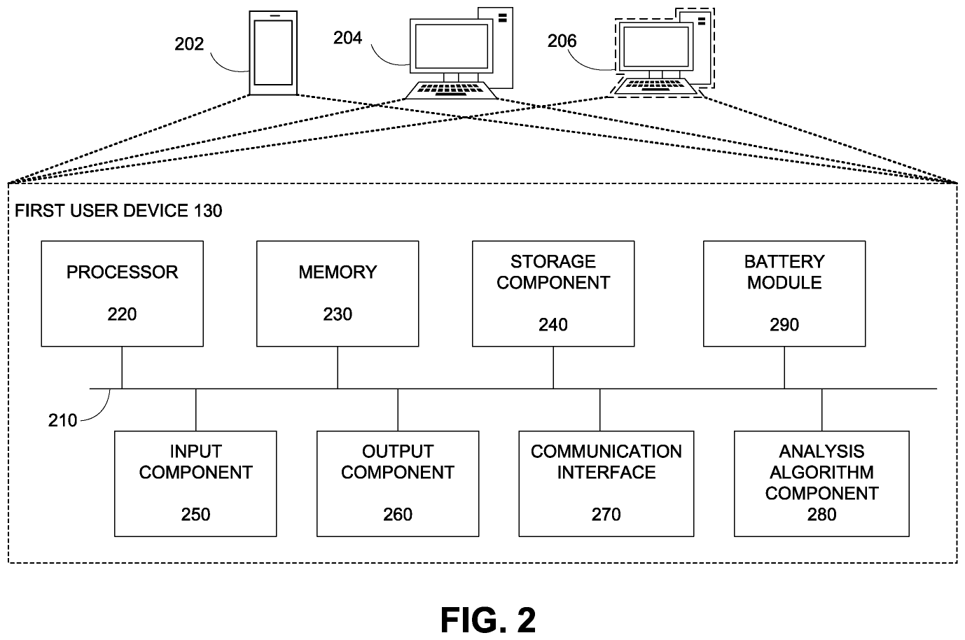

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment in which systems and/or methods described herein may be implemented. As shown in FIG. 1, the environment may execute within a cloud computing system 102. The cloud computing system 102 may include one or more elements 103-113, as described in more detail below. As further shown in FIG. 1, the environment may include a network 126, a first user device 134, and/or a base station 144. Devices and/or elements of the environment may interconnect via wired connections and/or wireless connections. It is important to note that first user device 134, as described herein, is a user device which may be used by the first user and/or the second user. In the later case, when it is used by the second user, user device 134 may also be called a second user device 134. For purposes of convenience in reading this description, the embodiment of the user device 134 as a first user device will be described, but it should be understood as interchangeably termed “second user device” at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 can operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 110. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 126 includes one or more wired and/or wireless networks. For example, the network 126 may include a cellular network, a public land mobile network (PLMN), a local area network (LAN), a wide area network (WAN), a satellite network, a private network, the Internet, and/or the like, and/or a combination of these or other types of networks. The network 126 enables communication among the devices of the environment.

First user device 134 may be possessed by a first user and includes one or more devices capable of receiving, generating, storing, processing, and/or providing information, as described elsewhere herein. First user device 134 may include a communication device and/or a computing device. For example, first user device 134 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 144 may support, for example, a cellular radio access technology (RAT). The base station may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the base station 144. The first user device 134 may transfer traffic between the base station 144 (e.g., using a cellular RAT), one or more base stations (e.g., using a wireless interface or a backhaul interface, such as a wired backhaul interface), and/or a core network. The first user device 134 may provide one or more cells that cover geographic areas.

The Second user device 154may be possessed by a second user and includes one or more devices capable of receiving, generating, storing, processing, and/or providing information, as described elsewhere herein. Second user device 154may include a communication device and/or a computing device, and may be connected to, or embedded anywhere within, a vehicle or other equipment known to be utilized in the transportation industry. For example, Second user device 154may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment may perform one or more functions described as being performed by another set of devices of the environment.

FIG. 2 is a diagram of components of first user device 134, according to an example of the present disclosure. First user device 134 may include a bus 210, a processor 220, a memory 230, a storage component 240, an input component 250, an output component 260, a communication interface 270, and battery module 290.

Bus 210 includes a component that permits communication among the components of First user device 134. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 220. In some embodiments, a non-transitory computer-readable medium stores instructions that, when executed by a processor, cause the processor to perform various functions.

Storage component 240 stores information and/or software related to the operation and use of First user device 134. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 134 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 134 (e.g., a display, a speaker, a user interface, and/or one or more light-emitting diodes (LEDs)). Output component 260 may include a display providing a GUI. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 134 to communicate with other devices, such as via a wired connection, a wireless connection, or a combination of wired and wireless connections. Communication interface 270 may permit first user device 134 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 134. Battery module 290 may supply power during field measurements by first user device 134. Battery module 290 permits First user device 134 to be a portable integrated device for conducting field measurements of propagation delay in a RAN.

First user device 134 may perform one or more processes described herein. First user device 134 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, first user device 134 may include additional components, fewer components, different components, or differently arranged components than those shown in FIGS. 2, 200. Additionally, or alternatively, a set of components (e.g., one or more components) of first user device 134 may perform one or more functions described as being performed by another set of components of first user device 134.

FIG. 2 is a diagram of components of first user device 134, according to an example of the present disclosure. First user device 134 may include a bus 210, a processor 220, a memory 230, a storage component 240, an input component 250, an output component 260, a communication interface 270, battery module 290 and Analysis algorithm component 280.

Bus 210 includes a component that permits communication among the components of First user device 134. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. According to an example, processor 220 is processor 220 of FIG. 2. Memory 230 may include one or more memories such as a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of First user device 134. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 134 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 134 (e.g., a display, a speaker, a user interface, and/or one or more light-emitting diodes (LEDs)). Output component 260 may include a display providing a GUI. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 134 to communicate with other devices, such as via a wired connection, a wireless connection, or a combination of wired and wireless connections. Communication interface 270 may include one or more short range communication interface modules and medium/long range communication interface modules, and may permit first user device 134 to receive information from another device and/or provide information to another device. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 134. Battery module 290 permits First user device 134 to be a portable integrated device for conducting field measurements of propagation delay in a RAN.

First user device 134 may perform one or more processes described herein. First user device 134 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Example embodiments Second user device 154may include a mobile device/user equipment (UE) 202, a personal computer 204, or a virtual computing system 206 which may include various implementations such as those of 106. Thus, implementations described herein are not limited to any specific combination of hardware circuitry and software.

The number and arrangement of components shown in FIG. 2 are provided as an example. In practice, first user device 134 may include additional components, fewer components, different components, or differently arranged components than those shown in FIG. 2. Additionally, or alternatively, a set of components (e.g., one or more components) of first user device 134 may perform one or more functions described as being performed by another set of components of first user device 134.

### System and Method for Rapid Control Target State Convergence Using Logically-Tiered Topology Instructions and Structured Execution Verification

The following description of illustrative embodiments is merely exemplary in nature and is not intended to limit the disclosure, its application, or uses.

Unless otherwise defined, all technical and scientific terms used herein have the same meaning as commonly understood by one of ordinary skill in the art. The terminology used in the description is for describing particular embodiments only and is not intended to be limiting.

As used herein, the singular forms “a,” “an,” and “the” include plural referents unless the context clearly dictates otherwise. The terms “comprising,” “including,” and “having” are intended to be inclusive and mean that there may be additional elements other than the listed elements. When the word “each” is used to refer to an element that was previously introduced as being at least one in number, the word “each” does not necessarily imply a plurality of the elements, but can also mean a singular element.

The present invention is directed to a computer-implemented system and method that enables users to interact with their business performance measured variables and receive AI-generated control actions to improve those measured variables. The system retrieves real-time performance data from external business sources, displays the data as interactive measured variables within a user interface, and when the user selects a measured variable as a focus goal with a defined target value, the system's AI Strategy Engine automatically generates control actions specifically tailored to achieve that target. The system further manages a structured accountability process for tracking strategy implementation, and in preferred embodiments incorporates gamified accountability, responsible agent designation, book-derived control actions, narrative performance outputs, and a closed-loop feedback mechanism that refines strategy recommendations based on tracked outcomes, as depicted in the accompanying figures.

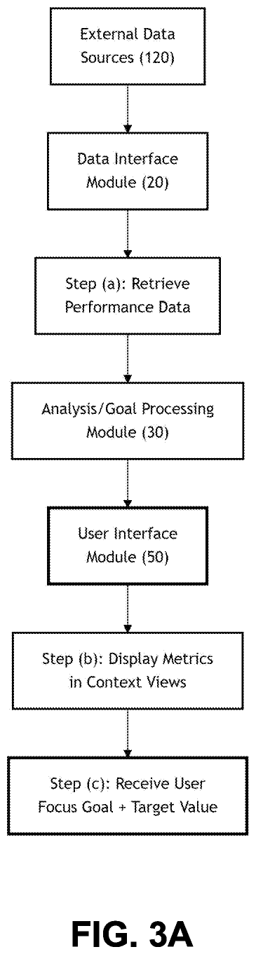

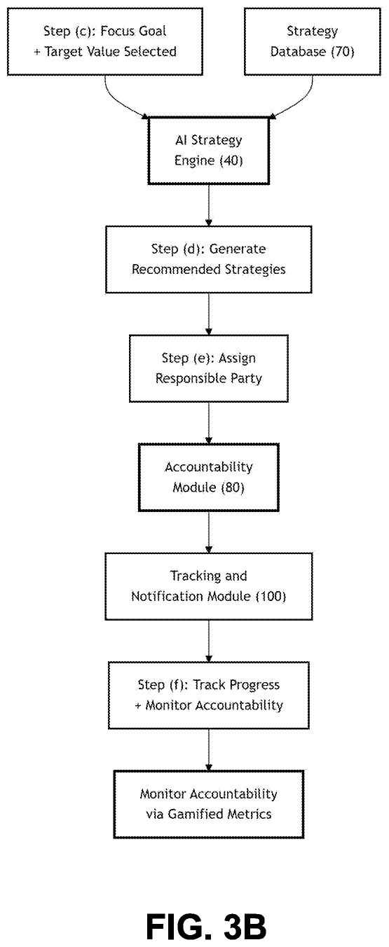

Referring now to FIG. 3A and FIG. 3B, the core method of the invention is illustrated as a two-part flowchart outlining the process for rapid goal achievement through measured variable interaction and logically-tiered topological strategy generation. FIG. 3A depicts how raw business data becomes interactive measured variables: the process begins with step (a), where performance data associated with a plurality of measured variables is retrieved from External Data Sources (120)—such as CRM systems, accounting platforms, and point-of-sale systems —via a Data Interface Module (20). The Analysis/Goal Processing Module (30) processes this data to compute performance indexs, identify trends, and detect measured variables requiring improvement. In step (b), the processed data is displayed as interactive measured variables in context presentation modesthrough a User Interface Module (50), enabling the user to visually assess performance across multiple dimensions. Preferably, the processed data displayed as interactive measured variables is at least a subset of the performance data. Preferably, the processed data displayed as interactive measured variables is at least a subset of the performance data.

Preferably, the processed data displayed as interactive measured variables is at least a subset of the performance data. Step (c) involves receiving the user's selection of a specific measured variable as a focus goal and defining a target value for improvement. Preferably, the user's selection of a specific measured variable as a focus goal and defining a target value for improvement is a user input identifying one of the measured variables as a focus control target and defining a target value associated with said focus control target.

Preferably, the user's selection of a specific measured variable as a focus goal and defining a target value for improvement is a user input identifying one of the measured variables as a focus control target and defining a target value associated with said focus control target. FIG. 3B depicts how the selected measured variable triggers AI strategy generation: a Database of Potential Control actions (70) feeds into step (d), where the AI Strategy Engine (40) generates recommended control actions specifically tailored to improve the selected measured variable and achieve the user's defined target value. Preferably, a recommended control action specifically tailored to improve the selected measured variable and achieve the user's defined target value is a generated control action tailored to attain the defined target value for the focus control target.

Preferably, a recommended control action specifically tailored to improve the selected measured variable and achieve the user's defined target value is a generated control action tailored to attain the target value for the focus control target.

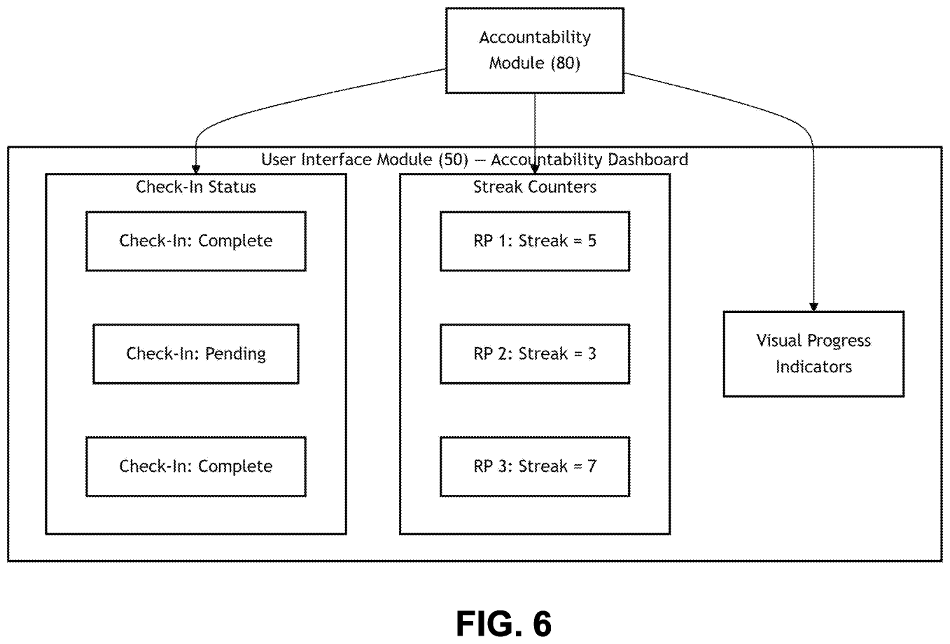

In step (e), a responsible agent may be assigned for strategy implementation through the Accountability Module (80). Step (f) tracks progress towards the target value via the Tracking and Notification Module (100) and manages a structured accountability process, including monitoring the completion of time-triggered accountability events, as further detailed in FIG. 6. Preferably, the focus goal is a focus control target. Preferably, the structured accountability process is a structured execution-verification process. Preferably, the time-triggered accountability events are time-triggered verification events. Preferably, data presented in the context presentation modes comprises operational-context data associated with the measured variable.

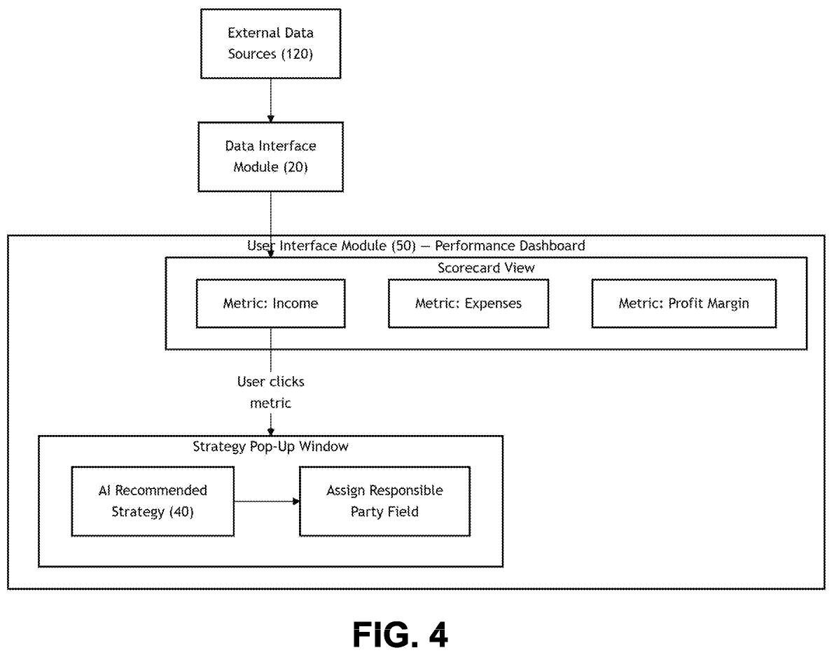

As shown in FIG. 4, the User Interface Module (50) presents a performance dashboard where each key business measured variable—such as income, expenses, profit margin, or customer acquisition cost—is displayed as an interactive element within a scorecard view. Each measured variable in the scorecard displays the measured variable's current value, its trend relative to previous periods, and an associated count of available AI-generated control actions tailored to improve that specific measured variable. When the user clicks on a measured variable or its displayed strategy count, the AI Strategy Engine (40) retrieves control actions from the Database of Potential Control actions (70) that are specifically relevant to improving the selected measured variable based on the user's current performance data and target value. Preferably, the triggering of AI strategy generation when the user clicks on a measured variable or its displayed strategy count is initiated upon receiving a user interaction directly with a displayed representation of the measured variable corresponding to the focus control target within the user interface.

A pop-up window presents these recommended control actions (e.g., “Optimize Sales Funnel,” “Reduce Cost Per Acquisition,” “Increase Upsell Conversion Rate”) ranked by relevance, along with a field for assigning a responsible agent (RP) to implement the selected strategy. This interface embodies the core invention: a user interacts directly with their business measured variables, and in response, the system automatically generates actionable control actions to improve those specific measured variables —transforming raw performance data into targeted improvement actions in a single interaction. Preferably, the scorecard view is an interactive multi-metric panel. Preferably, the displayed interactive element of the measured variable is a displayed representation corresponding to the focus control target. Preferably, the recommended control actions are ordered according to suitability. Preferably, the Measured variable Score view detailing a single measured variable is a granular view of a single measured variable.

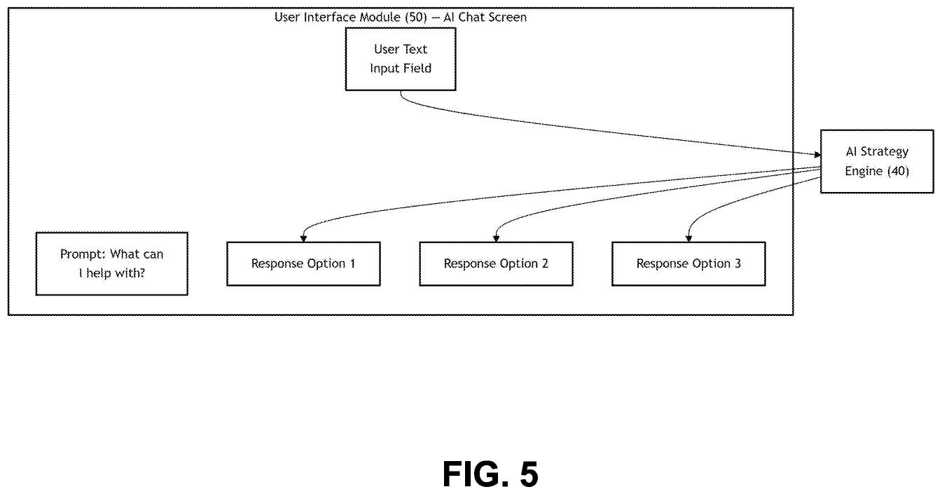

FIG. 5 illustrates a conversational AI interaction screen within the User Interface Module (50), displaying a prompt such as “What can I help with?” followed by response options. This interface facilitates user engagement by allowing direct input to query the system or receive guidance, enhancing the system's accessibility and interactivity for goal-setting tasks.

Referring to FIG. 6, the gamified accountability dashboard displays streak counters and check-in statuses to motivate responsible parties. Visual indicators, such as progress bars or checkmarks, show the completion of time-triggered accountability events. The streak counter is increased with consecutive check-ins, fostering consistent engagement and accountability, managed by the Accountability Module (80) and displayed via the User Interface Module (50). Preferably, the gamified accountability dashboard employs a reinforcement-based metric. Preferably, the streak counter is a verification streak value. Preferably, the verification streak value is increased upon recorded completion of consecutive time-triggered verification events.

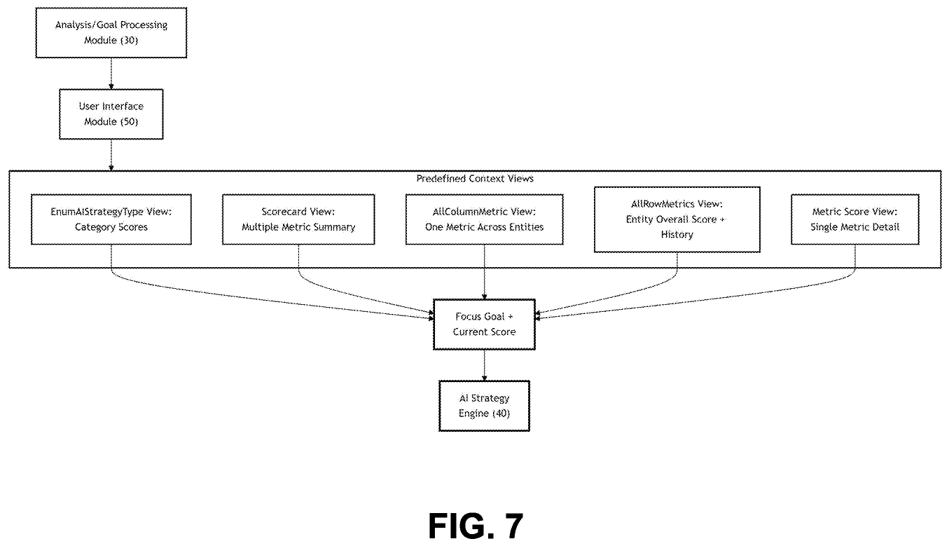

FIG. 7 depicts various context presentation modes for data presentation within the User Interface Module (50), each designed to help users identify which measured variables need improvement and to facilitate direct interaction with those measured variables for strategy generation. Preferably, the context presentation modes are selectable system-state presentation modes.

The presentation modes include: the EnumAIStrategyType view (showing performance indexs by strategy category, enabling users to identify underperforming categories), Scorecard view (aggregating multiple measured variables side by side with strategy counts, enabling rapid comparison and focus goal selection), AllColumnMeasured variable view (comparing a single measured variable across multiple entities such as franchise locations, enabling identification of underperformers), AllRowMeasured variables view (showing an entity's overall score with historical trend, enabling trajectory assessment), and Measured variable Score view (detailing a single measured variable with its current value, target, and available control actions). Preferably, the Scorecard view aggregating multiple measured variables is a multi-measured variable panel view aggregating multiple measured variables.

These presentation modes, supported by the Analysis/Goal Processing Module (30), present performance data in formats that surface improvement opportunities, with each view incorporating the current score relative to the goal so the user can immediately interact with any measured variable to trigger AI strategy generation via the AI Strategy Engine (40). Preferably, the context presentation modes are selectable operational-context views. Preferably, the Scorecard view is a multi-metric panel view. Preferably, the AllColumnMeasured Variable view compares one measured variable across multiple nodes. Preferably, the Measured Variable Score view is a detailed view of a single metric.

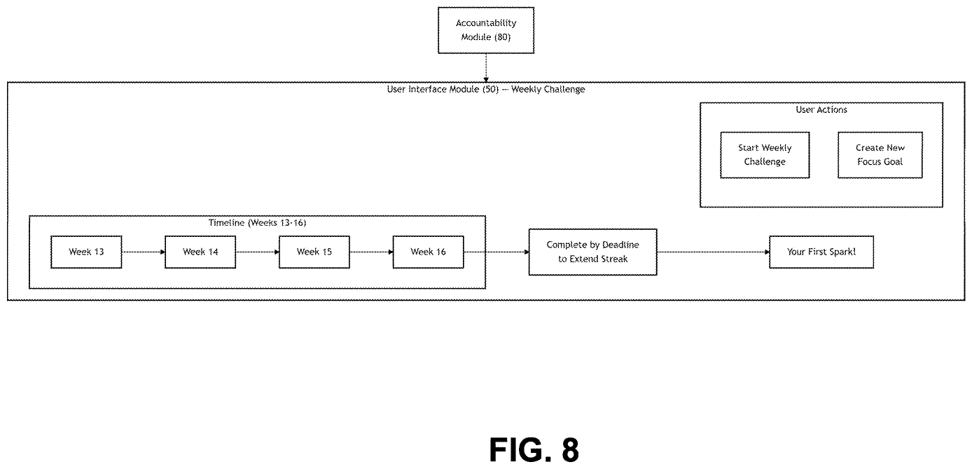

As illustrated in FIG. 8, the User Interface Module (50) includes a gamified weekly challenge screen encouraging users to complete tasks by a deadline to extend their streak. The interface displays a timeline and options to either start a weekly challenge or create a new focus goal. This gamification, managed by the Accountability Module (80), motivates users to maintain consistent engagement, with visual cues to celebrate milestones. Preferably, the hierarchical relationship is a tiered topology. Preferably, drilling down from the aggregated parent view to display individual child entity performance measured variables is selective drill-down to display performance measured variables for individual child nodes within the tiered topology.

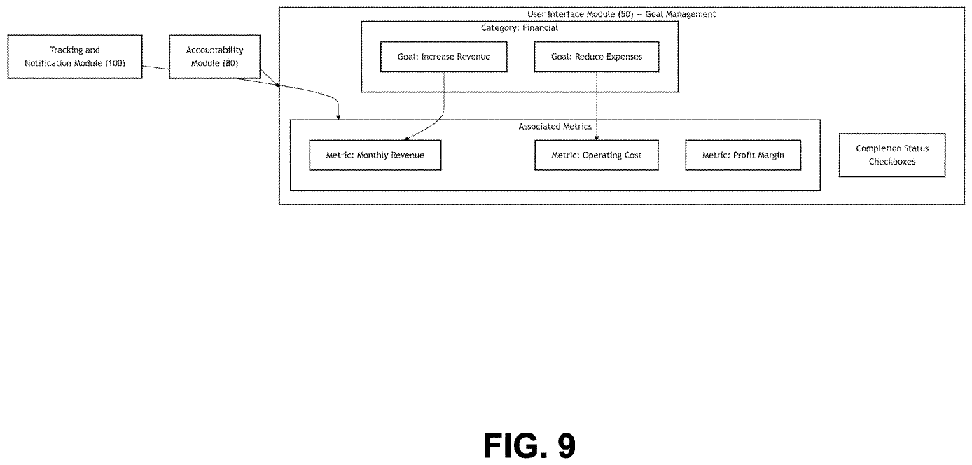

FIG. 9 shows a goal management dashboard within the User Interface Module (50), categorizing goals (e.g., Financial) and displaying associated measured variables for tracking progress. Checkboxes or similar indicators allow users to mark tasks or measured variables as complete, providing a clear overview of goal status and facilitating interaction with the Accountability Module (80) and Tracking and Notification Module (100).

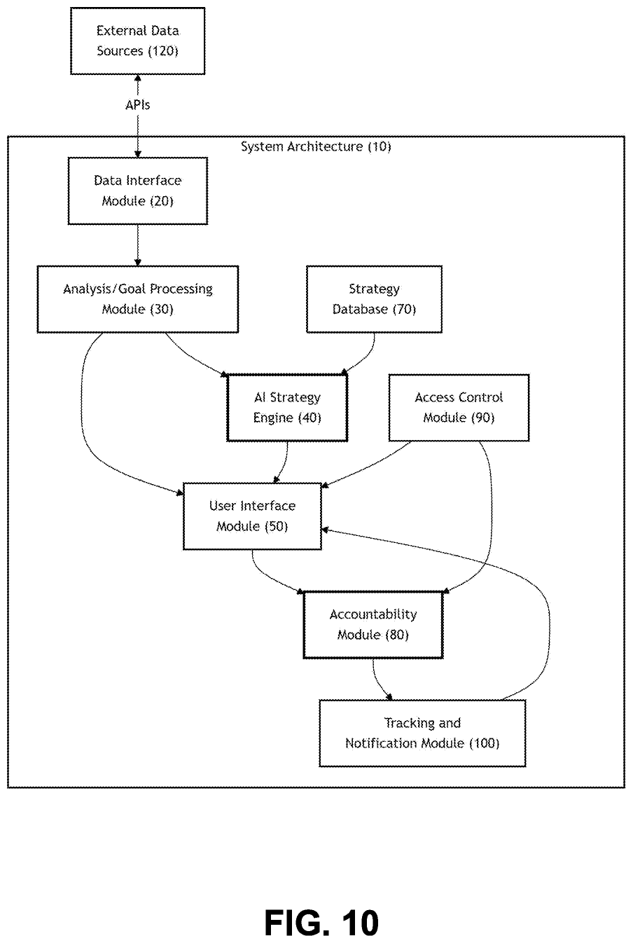

Referring to FIG. 10, the system architecture (10) comprises interconnected modules executed by one or more processors. The Data Interface Module (20) retrieves performance data from External Data Sources (120) via APIs. The Analysis/Goal Processing Module (30) analyzes this data to identify focus goals and process user inputs. Preferably, identifying focus goals and processing user inputs is identifying potential focus control targets based on analysis of the retrieved performance data prior to step (c). The AI Strategy Engine (40) generates tailored control actions using the Strategy Database (70). Preferably, the AI Strategy Engine (40) is an artificial intelligence (AI) strategy engine.

The User Interface Module (50) displays data and facilitates interaction, while the Accountability Module (80) manages responsible agent designations and check-ins. The Tracking and Notification Module (100) monitors progress and sends notifications, and the Access Control Module (90) restricts data access to ensure security and focus. Preferably, the restricted data access to ensure security and focus is limited electronic access to system information, restricted primarily to data and functions related to the focus control target and generated control action assigned to the responsible agent.

Preferably, the identified focus goals are potential focus control targets. Preferably, the Access Control Module enables limited electronic access to system information related to a selected focus control target and an associated control action. Preferably, notifications transmitted by the Tracking and Notification Module are system alerts.

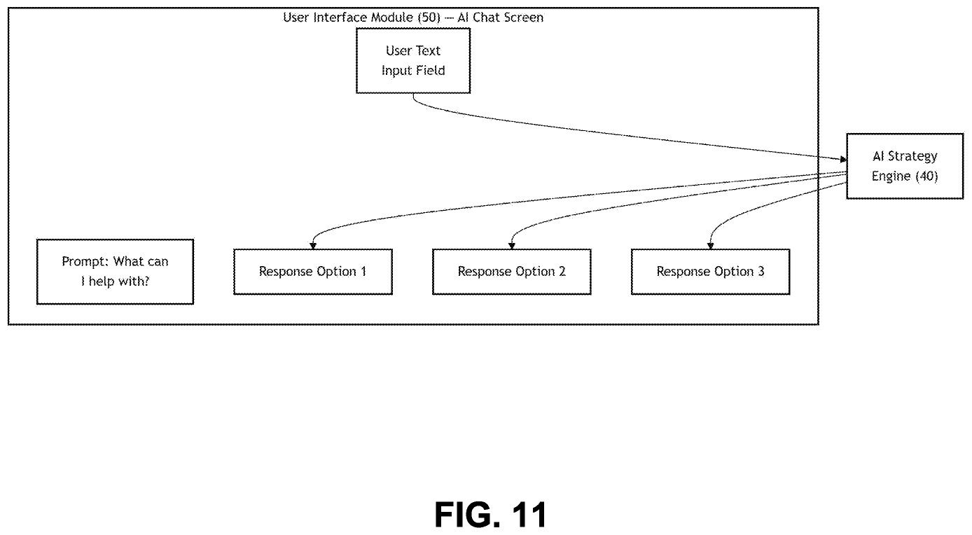

FIG. 11 replicates the conversational AI interaction screen from FIG. 5, reinforcing the system's user-friendly interface for engaging with the AI Strategy Engine (40) and other modules. The consistent design ensures users can easily navigate and interact with the system across different sessions or tasks.

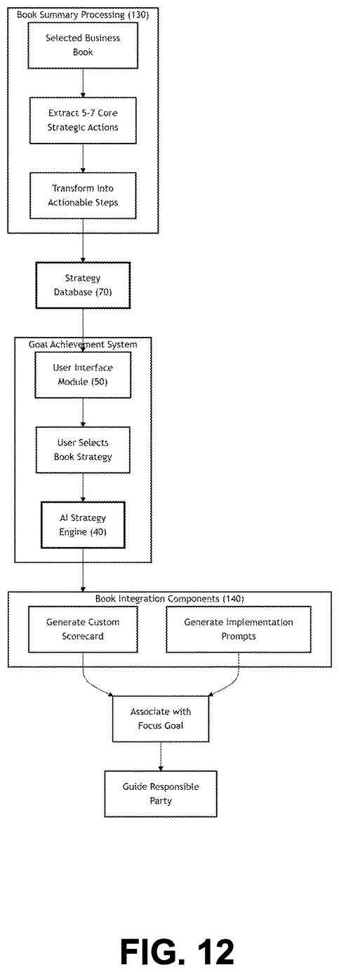

As depicted in FIG. 12, the system integrates control actions from external reference sources, such as business books, into the goal achievement workflow. The Book Summary Processing component (130) extracts key control actions (e.g., 5-7 core concepts) from selected books, transforming them into actionable steps stored in the Strategy Database (70). Preferably, the selected books are external reference sources.

The Goal Achievement System allows users to select these control actions via the User Interface Module (50), with Book Integration Components (140) generating custom scorecards and implementation prompts to guide the responsible agent in applying selected strategic actions towards achieving the target value. Preferably, the selected strategic actions towards achieving the target value are selected optimization-directed actions towards attaining the target value. Preferably, the custom scorecards are interactive multi-measured variable panels.

This process enriches strategy options and provides educational support tailored to the user's context. Preferably, the book summaries are electronic condensed representations of external reference resources. Preferably, the extracted key control actions are identified optimization-directed actions. Preferably, the custom scorecards are interactive multi-metric panels. Preferably, the implementation prompts are implementation cues.

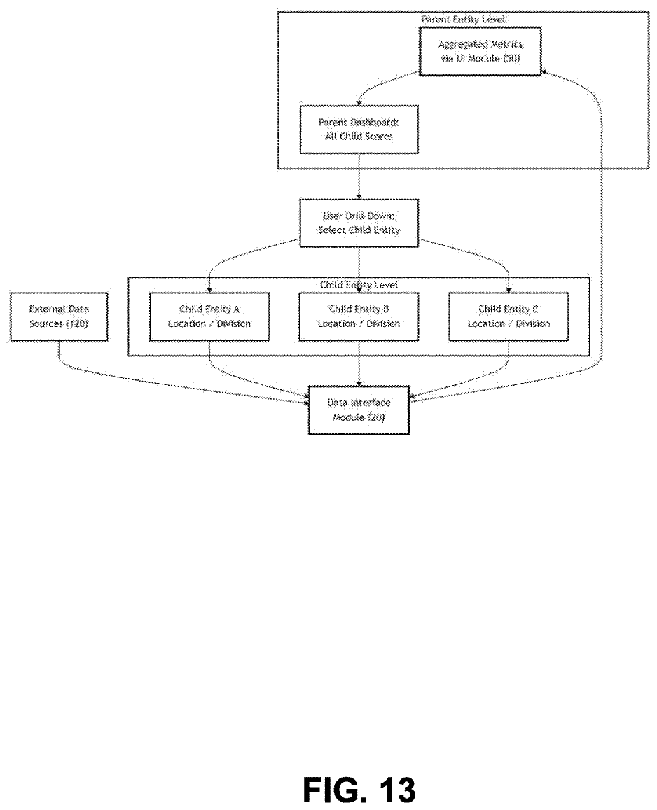

Referring to FIG. 13, the Data Interface Module (20) retrieves performance data from a plurality of entities organized in a hierarchical relationship, such as a parent organization (e.g., a franchisor) with multiple subsidiary child entities (e.g., franchisee locations or divisions). Preferably, the entities are nodes.

The User Interface Module (50) presents aggregated performance measured variables at the parent-entity level, providing a consolidated view of organizational performance. A user may select a child entity to drill down from the aggregated parent view to display individual child entity performance measured variables, facilitating comparative analysis across the organizational structure and enabling identification of underperforming or high-performing entities within the hierarchy. Preferably, each entity is a node. Preferably, the hierarchical relationship is a tiered topology. Preferably, the parent-entity level is a parent-node level.

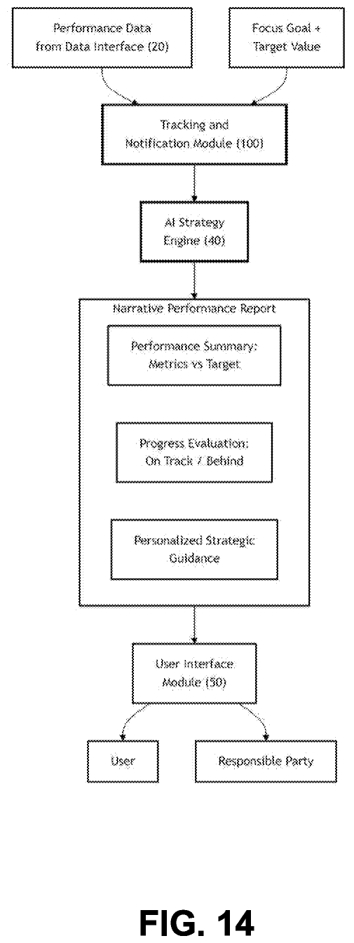

Referring to FIG. 14, the Tracking and Notification Module (100) cooperates with the AI Strategy Engine (40) to generate periodic narrative performance outputs. Each report summarizes the performance data relative to the focus goal, evaluates the user's progress towards the defined target value, and provides personalized strategic guidance based on current performance trends. The report is presented via the User Interface Module (50) to the user, the designated responsible agent, or both, thereby facilitating data-driven advisory conversations and informed decision-making without requiring the user to manually interpret raw measured variables. Preferably, the narrative performance outputs are alphanumeric performance outputs. Preferably, the personalized strategic guidance is personalized optimization-directed guidance.

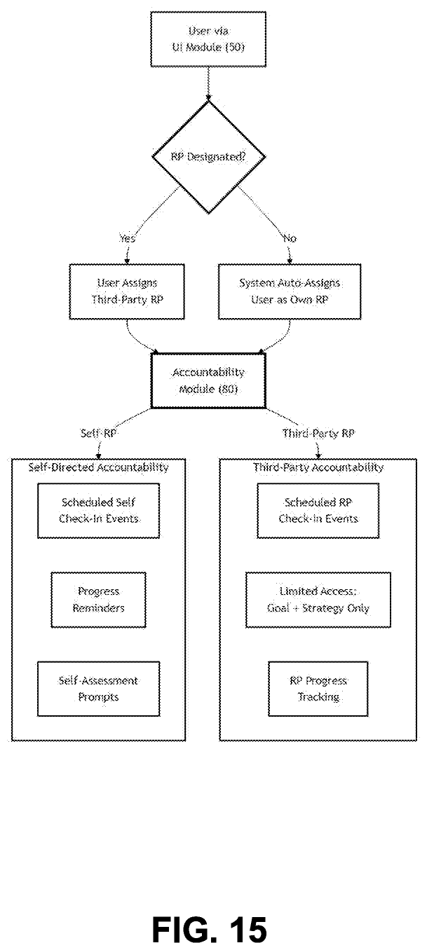

Referring to FIG. 15, the Accountability Module (80) manages the responsible agent designation process. When a user explicitly assigns a third-agent responsible agent, the system associates that agent with the focus goal and recommended strategy. When no responsible agent is affirmatively designated by the user, the Accountability Module (80) automatically designates the user as the responsible agent and manages a self-directed accountability process. The self-directed process includes time-triggered self-check-in events monitored by the system, progress reminders delivered via the Tracking and Notification Module (100), and self-assessment prompts presented via the User Interface Module (50), thereby supporting individual goal pursuit without requiring designation to a third agent. Preferably, the self-directed accountability process is a self-directed execution-verification process. Preferably, the self-assessment prompts are self-assessment cues.

In some embodiments, the User Interface Module (50) provides an interactive tutorial or guided workflow designed to lead a user through the process of selecting a focus goal, generating a recommended strategy via the AI Strategy Engine (40), and assigning a responsible agent, all within a predefined short time duration (e.g., under five minutes). Preferably, the interactive tutorial or guided workflow designed to lead a user through the process of selecting a focus goal, generating a recommended strategy via the AI Strategy Engine (40), and assigning a responsible agent is initiating the execution-verification process via an interactive guided setup sequence presented on the user interface, designed to facilitate completion of steps in a predefined short time duration.

The interactive tutorial may present step-by-step prompts, pre-populated inputs based on AI-identified goals, and confirmation screens that streamline the setup process, thereby reducing adoption barriers and enabling rapid onboarding for new users. Preferably, the interactive tutorial or guided workflow is an interactive guided setup sequence. Preferably, the AI-identified goals are potential focus control targets.

In some embodiments, the Database of Potential Control actions (70) is organized based on functional groupings associated with the measured variables, such as financial control actions, operational control actions, customer engagement control actions, and growth control actions. When the AI Strategy Engine (40) generates recommended control actions, it prioritizes control actions relevant to the functional category of the selected focus goal, ensuring that the recommendations are contextually appropriate. The database is further configurable to include custom control actions defined by a user or organization, allowing enterprises to encode their proprietary best practices alongside the system's curated strategy library. Preferably, the custom control actions defined by a user or organization are custom control actions defined by a user or supervisory domain.

Preferably, the functional groupings are functional categories associated with the measured variables. Preferably, the control actions relevant to the functional category are control actions applicable to the functional category of the selected focus goal. Preferably, the organization is a supervisory domain.

In some embodiments, the Tracking and Notification Module (100) is further configured to calculate variable indices based on goal types selected from a group comprising at least: increase KPI (measuring upward movement toward a target), decrease KPI (measuring downward movement toward a target), maintain KPI within range (measuring stability within defined bounds), and achieve baseline (measuring whether a minimum threshold has been reached). Preferably, achieve baseline is attain baseline. These calculated scores may be normalized to a predefined range for consistent comparison across different measured variable types and entities. Preferably, the goal types are control target types. Preferably, each KPI is a measured variable. Preferably, the calculated variable indices are metric scores. Preferably, the goal types selected from a group comprising at least increase KPI, decrease KPI, maintain KPI within range, and achieve baseline are control target types selected from a group comprising at least increase measured variable, decrease measured variable, maintain measured variable within range, and attain baseline.

Referring now to FIG. 15, in some embodiments, the designated responsible agent may be the user themselves. When no responsible agent is affirmatively designated, the Accountability Module (80) automatically designates the user as the responsible agent. As illustrated in FIG. 15, when the user self-designates as the responsible agent, the system manages a self-directed accountability process including time-triggered self-check-in events, progress reminders, and self-assessment prompts, thereby supporting individual goal pursuit without requiring designation to a third agent.

In some embodiments, the Database of Potential Control actions (70) comprises control actions dynamically generated by a trained machine learning model. The AI Strategy Engine (40) may analyze the performance data, character-based information, and the selected focus goal to generate novel control actions not previously stored, and may store these dynamically generated control actions in the database for subsequent retrieval and recommendation to other users or for the same user's future goal-setting activities. Preferably, the character-based information is system-state data associated with the measured variable as presented within the user interface.

Preferably, the character-based information includes operational-context data associated with the selected measured variable. Preferably, the dynamically generated control actions are stored for subsequent retrieval and use in generating additional control actions.

Referring now to FIG. 14, in some embodiments, the Tracking and Notification Module (100) generates periodic narrative performance outputs aggregating the performance data relative to the focus goal, evaluating progress towards the target value, and providing personalized strategic guidance. As depicted in FIG. 14, the Tracking and Notification Module (100) cooperates with the AI Strategy Engine (40) to produce said outputs, which may be presented via the User Interface Module (50) to the user, the designated responsible agent, or both, thereby facilitating data-driven advisory conversations and informed decision-making.

Referring now to FIG. 13, in some embodiments, the Data Interface Module (20) retrieves performance data from a plurality of entities organized in a hierarchical relationship, such as a parent organization with multiple subsidiary locations or divisions. As depicted in FIG. 13, the User Interface Module (50) is configured to present aggregated performance measured variables at a parent-entity level and to enable selective drill-down to display performance measured variables for individual child entities within the hierarchy, facilitating comparative analysis across the organizational structure.

To exemplify the system's operation, consider a business user aiming to increase monthly sales revenue. The Data Interface Module (20) retrieves sales data from a CRM system, which the Analysis/Goal Processing Module (30) analyzes to identify “Increase Monthly Sales Revenue” as a focus goal, displayed via the User Interface Module (50) as shown in FIG. 4. The user selects this goal, sets a 20% increase target, and the AI Strategy Engine (40) recommends control actions like “Optimize Sales Funnel,” displayed in a pop-up (FIG. 4). The user assigns the Sales Manager as the responsible agent, managed by the Accountability Module (80). The Tracking and Notification Module (100) monitors funnel measured variables (e.g., conversion rates) and tracks check-ins via the streak counter (FIG. 6). The user may also select book-derived control actions (FIG. 12), generating tailored scorecards and prompts to guide implementation, tracked via the dashboard in FIG. 9.

In some embodiments, the methods and system described herein may be implemented as instructions stored on a non-transitory computer-readable storage medium, such as a hard disk drive, solid-state drive, read-only memory (ROM), flash memory, optical disc, or other tangible storage device. When executed by one or more processors, the stored instructions cause the system to perform the steps of retrieving performance data via the Data Interface Module (20), displaying measured variables via the User Interface Module (50), receiving user inputs identifying a focus goal and target value, generating recommended control actions via the AI Strategy Engine (40), assigning a responsible agent, and tracking progress using gamified measured variables via the Tracking and Notification Module (100) and Accountability Module (80). The non-transitory computer-readable medium may further store instructions for integrating book-derived control actions, managing access control, and presenting data within multiple context presentation modes. Preferably, the focus goal is a focus control target. Preferably, the gamified measured variables are reinforcement-based metrics. Preferably, the context presentation modes are operational-context views.

In some embodiments, the Tracking and Notification Module (100) provides updated performance data reflecting tracked progress and accountability event completion rates to the AI Strategy Engine (40) on a periodic or event-triggered basis. Preferably, the accountability event completion rates are verification-event completion data.

The AI Strategy Engine (40) incorporates this updated performance data, including which previously recommended control actions correlated with successful accountability event completion and progress towards the target value, to refine and adapt subsequent strategy recommendations. This closed-loop feedback mechanism enables the system to continuously improve the relevance and effectiveness of generated control actions based on actual tracked outcomes, such that strategy recommendations become increasingly tailored to the user's specific performance patterns and goal-achievement behaviors over time. Preferably, the tracked outcomes are tracked measured results. Preferably, the relevance and effectiveness of generated control actions corresponds to control action suitability. Preferably, the subsequent strategy recommendations are subsequent control action recommendations.

In some embodiments, the Tracking and Notification Module (100) delivers accountability event reminders, progress updates, and strategic guidance notifications via a plurality of communication channels, including at least one of: in-app notifications presented via the User Interface Module (50), electronic mail communications, short message service (MOBILE SHORT-FORM COMMUNICATION) text communications, and push notifications delivered to a mobile device associated with the user or the designated responsible agent. The selection of communication channels may be configurable by the user or automatically determined by the system based on user preferences, notification urgency, or accountability event type. Preferably, the accountability event reminders are time-triggered alerts for verification events. Preferably, the progress updates and strategic guidance notifications are progress system alerts. Preferably, the in-app notifications are in-application system alerts. Preferably, the push notifications are push alerts.

While a particular form of the disclosure has been illustrated and described, it will be apparent that various modifications can be made without departing from the spirit and scope of the disclosure. For example, alternative gamification mechanics, such as points systems, badges, or leaderboards, could replace or supplement the streak counter (FIG. 6). The AI Strategy Engine (40) could employ advanced machine learning models to predict strategy success rates or identify optimal targets. The system could also integrate with additional external data sources, such as project management tools, personal health trackers, or social media platforms, or adapt for personal goal achievement outside of purely business contexts, expanding its suitability. Accordingly, it is not intended that the disclosure be limited, except as by the appended claims.

While particular embodiments have been described, alternatives, modifications, variations, improvements, and substantial equivalents that are or may be presently unforeseen may arise to applicants or others skilled in the art. Accordingly, the appended claims are intended to embrace all such alternatives, modifications, variations, improvements, and substantial equivalents.

### Conclusion

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer. It is to be understood that the present technology contemplates that, to the extent possible, one or more features of any implementation can be combined with one or more features of any other implementation.

While the above description details certain embodiments of the invention and describes the best mode contemplated, no matter how detailed the above appears in character-based content, the invention can be practiced in many ways. Therefore, implementation details may vary considerably while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated.

Any specific manifestations of these and other similar example processes are not intended to be limiting to the disclosure. Any suitable manifestation of these and other similar example processes can be selected within the scope of the illustrative embodiments.

Thus, a computer-implemented method, system or apparatus, and computer program product are provided in the illustrative embodiments for Systems and Methods for Rapid Control target state Convergence Using Logically-Tiered Topology Instructions and Structured Execution verification and other related features, functions, or operations. Where an embodiment or a portion thereof is described with respect to a type of device, the computer-implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present disclosure may be a system, a method, and/or a computer program product at any possible technical detail level of integration. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on a dedicated system or user's computer, partly on the user's computer or dedicated system as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A computer-implemented method for driving a measured variable toward a target value, the method comprising:
(a) electronically retrieving performance data associated with a plurality of measured variables from at least one external data source via a data interface;
(b) displaying at least a subset of said performance data via a user interface;
(c) receiving, via the user interface, a user input identifying one of said measured variables as a focus control target and defining a target value associated with said focus control target;
(d) automatically generating, via an artificial intelligence (AI) strategy engine, at least one generated control action tailored to attain the defined target value for the focus control target, wherein said generation is based at least in part on analysis of the performance data corresponding to the focus control target and the defined target value; and
(e) electronically tracking progress towards the defined target value and managing a structured execution-verification process, said process including monitoring completion of time-triggered verification events.

2. The method of claim 1, wherein the tracked progress and verification-event completion data are provided as updated performance data to the AI strategy engine, and the AI strategy engine incorporates said updated performance data to refine and adapt subsequent generated control actions, thereby forming a closed-loop feedback mechanism that continuously improves control action suitability based on actual tracked measured results.

3. The method of claim 1, further comprising receiving, via the user interface, a user designation designating a responsible agent for implementing the generated control action associated with the focus control target, and associating the designated responsible agent with the structured execution-verification process.

4. The method of claim 3, wherein the structured execution-verification process includes monitoring completion of time-triggered verification events using a reinforcement-based measured variable, and wherein the reinforcement-based measured variable comprises a verification streak value that is increased upon recorded completion of consecutive time-triggered verification events by the designated responsible agent.

5. The method of claim 1, wherein automatically generating the generated control action is initiated upon receiving a user interaction directly with a displayed representation of the measured variable corresponding to the focus control target within the user interface, and wherein the structured execution-verification process further comprises delivering time-triggered signals for verification events and progress system signals via a plurality of communication channels, including at least one of: in-application system signals, electronic communications, short message service (mobile short-form communication) communications, and push signals delivered to a mobile device.

6. The method of claim 1, wherein generating the generated control action further comprises analyzing a current performance index calculated for a focus control target and system-state data associated with the measured variable as presented within the user interface.

7. The method of claim 1, further comprising guiding the user through selecting the focus control target, generating the generated control action, and initiating the execution-verification process via an interactive guided setup sequence presented on the user interface, designed to facilitate completion of steps in a predefined short time duration.

8. The method of claim 3, further comprising enabling a designated responsible agent limited electronic access to system information, restricted primarily to data and functions related to the focus control target and generated control action assigned to said responsible agent.

9. The method of claim 1, wherein the AI strategy engine is further configured to identify potential focus control targets based on analysis of the retrieved performance data prior to step (c).

10. The method of claim 1, further comprising:
(f) accessing electronic condensed interface elements of external reference sources, wherein said condensed interface elements contain identified optimization-directed actions;
(g) extracting a plurality of said optimization-directed actions from said condensed interface elements;
(h) generating, via the user interface, an interactive multi-measured variable panel and an implementation instruction based on a selection of said extracted optimization-directed actions; and
(i) associating said interactive multi-measured variable panel and implementation instruction with the focus control target to guide implementation of said selected optimization-directed actions towards attaining the target value.

11. A computer-implemented system for driving a measured variable toward a target value, the system comprising:
(a) one or more processors;
(b) a memory storing instructions;
(c) a data interface module configured, when executed by the processors, to electronically retrieve performance data associated with a plurality of measured variables from at least one external data source;
(d) a user interface module configured, when executed by the processors, to display at least a subset of said performance data and to receive user inputs identifying a focus control target and a target value;
(e) an artificial intelligence (AI) strategy engine configured, when executed by the processors, to automatically generate at least one generated control action tailored to attain the target value for the focus control target based at least in part on analysis of the performance data and the target value; and
(f) a tracking module configured, when executed by the processors, to monitor progress towards the target value and manage a structured execution-verification process including monitoring completion of time-triggered verification events.

12. The system of claim 11, wherein the user interface module displays measured variables within a plurality of selectable system-state presentation modes, including at least one of: an overall grouping mode, a multi-measured variable panel view aggregating multiple measured variables, a view comparing one measured variable across multiple nodes, and a granular view of a single measured variable.

13. The system of claim 11, wherein the AI strategy engine generates the generated control action by selecting from a database of potential control actions organized based on functional groupings associated with the measured variables, and ordering control actions applicable to a functional category of the focus control target.

14. The system of claim 11, further comprising an execution-verification module configured, when executed by the processors, to associate a designated responsible agent with the focus control target and generated control action, wherein when no responsible agent is affirmatively designated by the user, the system automatically designates the user as the responsible agent and manages a self-directed execution-verification process including time-triggered self-check-in events and self-assessment instruction.

15. The system of claim 11, wherein the AI strategy engine generates control actions dynamically using a trained machine learning model based on the performance data and the focus control target, and stores said dynamically generated control actions in a database for subsequent retrieval and use in generating generated control actions.

16. The system of claim 11, wherein the tracking module generates periodic character-based performance outputs aggregating the performance data relative to the focus control target, evaluating progress towards the target value, and providing personalized optimization-directed guidance, and presents said outputs via the user interface module.

17. The system of claim 11, wherein the data interface module retrieves performance data from a plurality of nodes organized in a tiered topology, and the user interface module is configured to present aggregated performance measured variables at a parent-node level and to enable selective drill-down to display performance measured variables for individual child nodes within the tiered topology.

18. The system of claim 11, wherein a database of potential control actions is configurable to include custom control actions defined by a user or supervisory domain.

19. The system of claim 11, wherein the tracking module is further configured to calculate variable indices based on control target types selected from a group comprising at least: increase measured variable, decrease measured variable, maintain measured variable within range, and attain baseline.

20. A non-transitory computer-readable storage medium storing instructions that, when executed by one or more processors, cause the processors to perform a method for driving a measured variable toward a target value, the method comprising:
(a) electronically retrieving performance data associated with a plurality of measured variables from at least one external data source via a data interface;
(b) displaying at least a subset of said performance data via a user interface;
(c) receiving, via the user interface, a user input identifying one of said measured variables as a focus control target and defining a target value associated with said focus control target;
(d) automatically generating, via an artificial intelligence (AI) strategy engine, at least one generated control action tailored to attain the defined target value for the focus control target, wherein said generation is based at least in part on analysis of the performance data corresponding to the focus control target and the defined target value; and
(e) electronically tracking progress towards the defined target value and managing a structured execution-verification process, said process including monitoring completion of time-triggered verification events.
